(19) United States
(12) Patent Application Publication
(10) Pub. No.: US 2025/0326179 A1
(43) Pub. Date: Oct. 23, 2025

(54) METHOD OF APPLYING RUBBER LINING TO THE INTERNAL SURFACE OF PIPING AND FITTINGS

(71) Applicant: ContiTech USA, Inc., Fairlawn, OH (US)

(72) Inventors: Gergely Szekely, Houston, TX (US); Matthias Liefer, Hannover (DE); Sergio Orozco, Akron, OH (US); Lance Miller, Uniontown, OH (US); Mohamad Bachir, Medina, OH (US)

(73) Assignee: ContiTech USA, Inc., 44333, OH (US)

(21) Appl. No.: 18/864,834

(22) PCT Filed: May 9, 2023
(86) PCT No.: PCT/US2023/066757

§ 371 Date: Nov. 11, 2024

Related U.S. Application Data
(60) Provisional application No. 63/364,553, filed on May 11, 2022.

(51) Int. Cl. B29C 63/34; B29C 63/28; B29C 63/48; F16L 57/06

(52) U.S. Cl. CPC B29C 63/34; B29C 63/28; B29C 63/481; B29C 63/486; F16L 57/06; B29C 2063/485

(57) ABSTRACT

A method of lining a piping assembly with rubber to form a rubber liner. An inner surface of the piping assembly is selected for lining. One or more containment devices are attached/inserted in the piping based on the selected surfaces. The inflatable bladder is introduced to an inner bore of the piping. The inflatable bladder is inflated to a predetermined pressure. An oven or autoclave is heated to a predetermined temperature. The piping assembly is introduced to the oven and heated until a predetermined curing temperature. The piping assembly is cooled for a predetermined cooling time and a rubber inner liner is formed on the selected surface.

### FIELD

The field to which the disclosure generally relates to piping and fittings and more particularly to hydraulic fracturing for oil and gas.

### BACKGROUND

Pump assemblies are used in oilfield applications to pump a fluid from the surface of the well to a wellbore at extremely high pressures. Such applications include hydraulic fracturing, cementing, and pumping through coiled tubing, among other applications. In the example of a hydraulic fracturing operation, a multi-pump assembly is often employed to direct an abrasive containing fluid, or fracturing fluid, through a wellbore and into targeted regions of the wellbore to create side “fractures” in the wellbore. To create such fractures, the fracturing fluid is pumped at extremely high pressures, sometimes in the range of 10,000 to 15,000 psi or more. In addition, the fracturing fluid contains an abrasive proppant which both facilitates an initial creation of the fracture and serves to keep the fracture “propped” open after the creation of the fracture. These fractures provide additional pathways for underground oil and gas deposits to flow from underground formations to the surface of the well. These additional pathways serve to enhance the production of the well.

However, the abrasive nature of fracturing fluids can degrade equipment, including, pumps, piping and fittings.

What is needed are techniques to mitigate equipment degradation.

### BRIEF DESCRIPTION OF THE DRAWINGS

FIG. 1 is a diagram illustrating a pipe or piping assembly coated with a material in accordance with one or more embodiments.

FIGS. 2A and 2B depict a flow diagram illustrating a method of fabricating and/or forming a piping assembly having a rubber lining in accordance with one or more embodiments.

### DETAILED DESCRIPTION

The following description of the variations is merely illustrative in nature and is in no way intended to limit the scope of the disclosure, its application, or uses. The description is presented herein solely for the purpose of illustrating the various embodiments of the disclosure and should not be construed as a limitation to the scope and applicability of the disclosure. In the summary of the disclosure and this detailed description, each numerical value should be read once as modified by the term “about” (unless already expressly so modified), and then read again as not so modified unless otherwise indicated in context. Also, in the summary of the disclosure and this detailed description, it should be understood that a value range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors had possession of the entire range and all points within the range.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Also, in some example embodiments, well-known processes, well-known device structures, and well-known technologies are not described in detail. Further, it will be readily apparent to those of skill in the art that in the design, manufacture, and operation of apparatus to achieve that described in the disclosure, variations in apparatus design, construction, condition, erosion of components, gaps between components may present, for example.

Pump assemblies are used in oilfield applications to pump a fluid from the surface of the well to a wellbore at extremely high pressures. Such applications include hydraulic fracturing, cementing, and pumping through coiled tubing, among other applications. In the example of a hydraulic fracturing operation, a multi-pump assembly is often employed to direct an abrasive containing fluid, or fracturing fluid, through a wellbore and into targeted regions of the wellbore to create side “fractures” in the wellbore. To create such fractures, the fracturing fluid is pumped at extremely high pressures, sometimes in the range of 10,000 to 15,000 psi or more. In addition, the fracturing fluid contains an abrasive proppant which both facilitates an initial creation of the fracture and serves to keep the fracture “propped” open after the creation of the fracture. These fractures provide additional pathways for underground oil and gas deposits to flow from underground formations to the surface of the well. These additional pathways serve to enhance the production of the well.

However, the abrasive nature of fracturing fluids can degrade equipment, including, pumps, piping and fittings.

Conventional approaches to mitigate this degradation are typically equipment specific.

One or more embodiments are disclosed that mitigate degradation of piping and equipment used for hydraulic fracturing and the like. Techniques include a relatively even bonding a thin layer or rubber to various internal surfaces of piping and fittings, including various internal geometries of steel piping, elbows, tees, valves and the like. It is appreciated that the term piping includes spool pipes, reducers, and the like.

The embodiments include an adaptive process and accommodate equipment with variations in dimensions and geometries.

The techniques utilize core equipment, such as an inflatable bladder, to line the variety of geometries. The techniques can be combined with rubber linings specifically designed for some equipment.

The embodiments can accommodate a low capital investment. The techniques can utilize an electric or gas heated oven as a source of heat instead of requiring a vulcanization chamber.

The embodiments can be transportable. For example, the equipment to form the rubber liner can be mounted on a trailer and launched close to customer sites.

It is appreciated that the embodiment can also be applied to other erosion intensive fields and/or applications, where non-standard or low-to-medium quantity parts are manufactured. One example is piping and equipment used in hydropower plant around the penstock, turbine and outlet area. The high velocity flow containing sediments has a high erosion potential for the piping and equipment

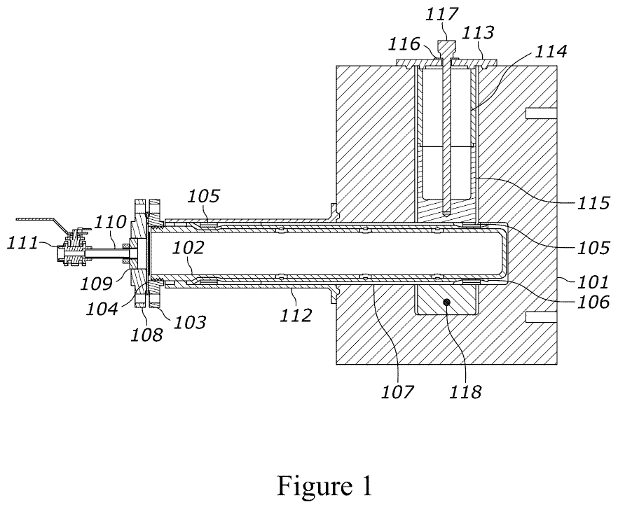

FIG. 1 is a diagram illustrating a pipe or piping assembly coated with a material in accordance with one or more embodiments. The coated pipe is provided for illustrative purposes and it is appreciated that suitable variations are contemplated. The piping is shown with an inflatable bladder and containment pieces.

The 101 piping includes an inflatable bladder pipe 102 and an inflatable bladder flange (flange 1) 103, a seal/gasket 104, a crimping ring/steel band 105 (can also include another crimping ring/steel band), an inflatable bladder 106, a rubber lining 107, a second inflatable bladder flange (flange 2) 108, a treaded male reducer 109, a threaded nipple 110, a valve 111, an external containment device 112, a lid containment device 113, a cylindrical containment device 114, a second cylindrical containment device 115, a washer 116, a threaded rod 117 and a cap containment device 118.

The rubber lining/liner 107 has a suitable thickness, such as about 1-3 mm and an inner diameter (ID) of the piping of about 1-7 inches.

The rubber lining 107 can be utilized for various piping or piping geometries, including tubular based elbows, tees (Ts), reducers, valves and the like.

The rubber lining 107 is comprised of a suitable material, such as such as Natural Rubber/Styrene Butadiene Rubber or Natural Rubber/Butadiene Rubber Compound and the like.

The rubber lining 107 is adhered to an inner surface of the piping by a suitable mechanism, such as vulcanized to steel and suitable for 50-80 ft/s flow velocity.

The rubber lining 107 is formed to have a suitable lifespan of at least about a year in one example.

The rubber lining 107 can compressed to the ID of the pipe using the inflatable bladder (106) inflatable packer hoses and/or the like. It is appreciated that other compression techniques can be used, such as using an inflatable packer.

The rubber lining 107 can be applied to piping of various stages of complexity.

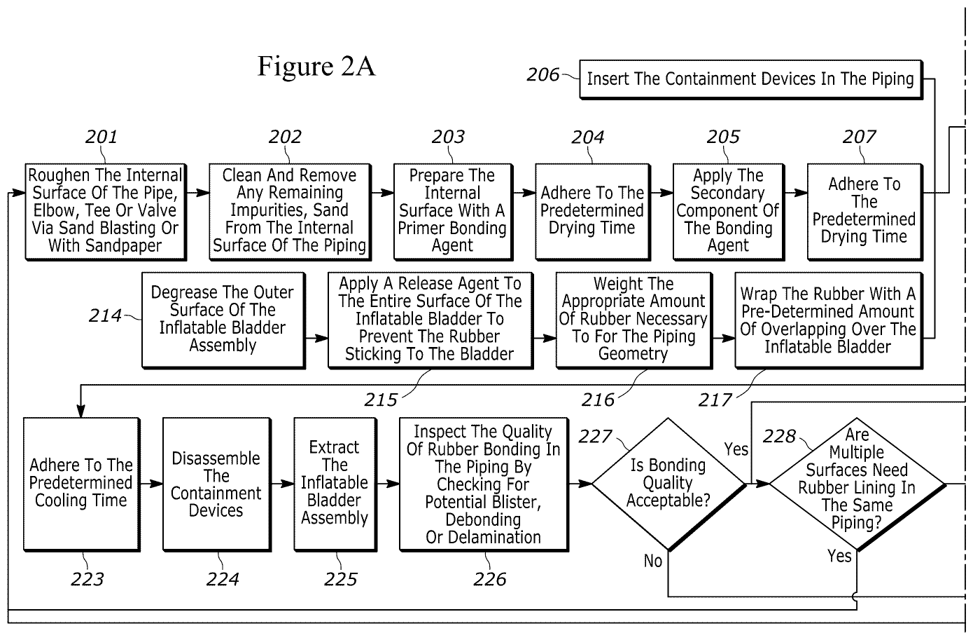

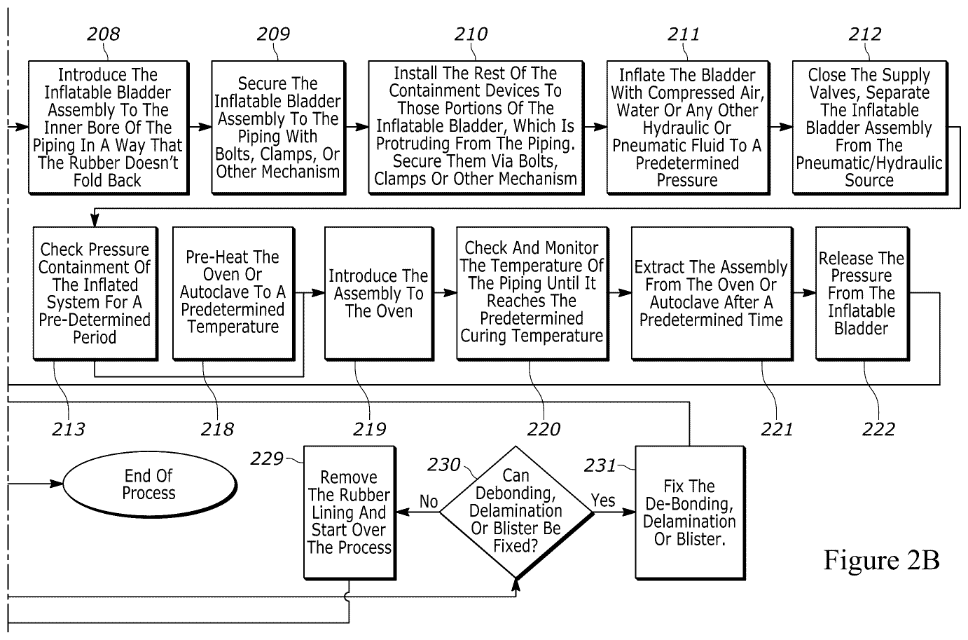

FIGS. 2A and 2B depict a flow diagram illustrating a method of fabricating and/or forming a piping assembly having a rubber lining in accordance with one or more embodiments. The method is provided for illustrative purposes and it is appreciated that suitable variations are contemplated. Further, it is appreciated that the method can include additional blocks or steps and omit recited steps in suitable variations of the method.

The method can be used with the piping of FIG. 1 to create the rubber lining 107.

Internal surfaces of equipment (pipe, elbow, tee, valve and the like) are roughened using sand blasting, sandpaper and/or the like at 201.

Remaining impurities and sand are removed from the internal surfaces at 202.

The internal surfaces are prepared with a primer bonding agent at 203.

A predetermined drying time is used or adhered to at 204.

Apply a secondary component of the bonding agent at 205.

Adhere to a predetermined drying time at 207.

Containment devices (such as cap containment device 118) are inserted in the equipment (piping) at 206.

An outer surface of an inflatable bladder assembly 106 is degreased at 214.

A release agent is applied to an entire surface of the inflatable bladder 106 to mitigate rubber/liner 107 sticking to the bladder at 215.

Select an appropriate amount of weight at 216 based on the piping geometry.

Wrap the rubber liner 107 with a pre-determined amount of overlapping over the inflatable bladder at 217.

The inflatable bladder assembly is introduced to an inner bore of the piping 101 so that the rubber lining 107 doesn't fold back at 208, in one example.

The inflatable bladder assembly is secured to the piping with bolts, clamps and/or the like at 209.

Remaining containment devices (e.g., 112, 113, 114, 115, 118) are installed to portions of the inflatable bladder, which is protruding from the piping at 210. They are secured by bolts, clamps, and the like.

The inflatable bladder 106 is inflated with compressed air, water and/or other hydraulic or pneumatic fluid to a predetermined pressure at 211.

Supply valves 111 are closed and the inflatable bladder assembly is separated from the pneumatic/hydraulic source at 212.

A containment pressure of the inflated system is checked for a pre-determined period at 213.

An oven or autoclave is pre-heated to a predetermined temperature at 218. Examples of suitable predetermined temperatures include 300 to 400 Fahrenheit (F)

The assembly including the piping is introduced to the oven or autoclave at 219.

A temperature of the piping is checked/monitored until it reaches a predetermined curing temperature at 220.

The assembly is removed from the oven at 221.

The pressure of the inflatable bladder 106 is released at 222.

Adhere to the predetermined cooling time at 223.

The one or more containment devices are removed/disassembled at 224.

The inflatable bladder assembly is extracted at 225.

A quality of a bonding of a rubber lining 107 with the inner surfaces of the piping is inspected at 226.

The quality of the bonding of the lining 107 is determined to be acceptable or non acceptable at 227.

If acceptable, a determination of if there are multiple or additional surfaces that need rubber lining 107 in the same piping 101 is needed at 228. If additional surfaces are to have rubber lining applied, the method turns to 201 for the additional surfaces.

If the bonding quality is not acceptable, a check on whether the bonding quality can be fixed is made at 230. If it can be fixed, the bonding is fixed at 231 and the method proceeds to 228.

If the bonding cannot be fixed, the rubber lining is removed at 229 and the method returns to 201.

In some aspects, the techniques described herein relate to a method of lining a piping 101 assembly with rubber, the method including: selecting an inner surface of the piping assembly for lining; inserting one or more containment devices in the piping based on the selected surfaces; introducing the inflatable bladder to an inner bore of the piping; inflating the inflatable bladder to a predetermined pressure; pre-heating an oven or autoclave to a predetermined temperature; introducing the piping assembly to the oven and heating until a predetermined curing temperature; and cooling the piping assembly for a predetermined cooling time and a rubber inner liner 106 is formed on the selected surface.

In some aspects, the techniques described herein relate to a method, further including: roughening the selected surface; removing impurities from the selected surface; applying a primer bonding agent to the selected surface; and applying a secondary bonding agent to the selected surface;

In some aspects, the techniques described herein relate to a method, further including: degreasing an outer surface of an inflatable bladder assembly; applying a release agent to the outer surface of the inflatable bladder assembly; selecting an amount by weight of rubber material based on the selected surface, the piping assembly and a geometry of the piping; and wrapping the selected rubber material over the inflatable bladder.

In some aspects, the techniques described herein relate to a method, further including securing the inflatable bladder to the piping prior to inflating the inflatable bladder.

In some aspects, the techniques described herein relate to a method, further including closing supply valves of the piping prior to inflating the inflatable bladder.

In some aspects, the techniques described herein relate to a method, including selecting one or more additional inner surfaces for applying a rubber liner and applying the rubber liner to the selected one or more additional inner surfaces.

In some aspects, the techniques described herein relate to a method, further including inspecting the rubber liner for bonding and/or delamination.

In some aspects, the techniques described herein relate to a method, further including removing the one or more containment devices.

In some aspects, the techniques described herein relate to a method of lining a piping assembly, the method including: roughening internal surfaces of piping; removing impurities from the internal surfaces; applying a primer bonding agent to the internal surfaces; applying a secondary bonding agent to the internal surfaces; inserting one or more containment devices in the piping; degreasing an outer surface of an inflatable bladder assembly; applying a release agent to the outer surface of the inflatable bladder assembly; selecting an amount by weight of rubber material based on the piping and a geometry of the piping; wrapping the selected rubber material over the inflatable bladder; introducing the inflatable bladder to an inner bore of the piping; securing the inflatable bladder to the piping; inflating the inflatable bladder to a predetermined pressure; closing supply valves of the piping; pre-heating an oven or autoclave to a predetermined temperature; introducing the piping to the oven and heating until a predetermined curing temperature; and the piping is removed from the oven and cooled for a predetermined cooling time and an inner liner 107 is formed on the inner surfaces.

In some aspects, the techniques described herein relate to a method, further including removing the one or more containment devices.

In some aspects, the techniques described herein relate to a method, further including inspecting a bonding of the rubber lining with the inner surfaces.

In some aspects, the techniques described herein relate to a piping assembly including: piping 101; an inflatable bladder 106 coupled to the piping 101; a valve 111 coupled to the inflatable bladder 106; a lid containment device 113 connected to a top of the piping 101; one or more containment devices 112, 114, 115 coupled to the piping 101; control circuitry connected to the inflatable bladder and having one or more processors configured to: select an inner surface of the piping assembly for lining; introduce rubber material into the inflatable bladder; inflate the inflatable bladder to a predetermined pressure; heat the piping assembly until a predetermined curing temperature and form a rubber liner on the inner surface.

In some aspects, the techniques described herein relate to an assembly, the one or more processors configured to cool the piping assembly for a predetermined cooling time.

In some aspects, the techniques described herein relate to an assembly, the one or more processers configured to inspect the rubber liner.

In some aspects, the techniques described herein relate to an assembly, further including an oven for heating the piping 101.

It should be added that ‘having’ does not exclude other elements or steps and ‘one’ or ‘one’ does not exclude a multitude. It should also be noted that characteristics described with reference to one of the above examples of execution can also be used in combination with other characteristics of other examples of execution described above. Reference signs in the claims are not to be regarded as a restriction.

Various illustrative logics, logical blocks, modules, and circuits described in connection with aspects disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor can be a microprocessor, but, in the alternative, processor can be any conventional processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration. Additionally, at least one processor can comprise one or more modules operable to perform one or more of the s and/or actions described herein.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product can include a computer readable medium having one or more instructions or codes operable to cause a computer to perform functions described herein.

Further, the actions of a method or algorithm described in connection with aspects disclosed herein can be embodied directly in hardware, in a software module executed by a processor, or a combination thereof. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal. In the alternative, processor and storage medium can reside as discrete components in a user terminal. Additionally, in some aspects, the s and/or actions of a method or algorithm can reside as one or any combination or set of codes and/or instructions on a machine-readable medium and/or computer readable medium, which can be incorporated into a computer program product.

As it employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner”, “adjacent”, “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

1. A method of lining a piping assembly with rubber, the method comprising:
selecting an inner surface of the piping assembly for lining;
inserting one or more containment devices in the piping based on the selected surfaces;
introducing the inflatable bladder to an inner bore of the piping;
inflating the inflatable bladder to a predetermined pressure;
pre-heating an oven to a predetermined temperature;
introducing the piping assembly to the oven and heating until a predetermined curing temperature; and
cooling the piping assembly for a predetermined cooling time and a rubber inner liner is formed on the selected surface.

2. The method of claim 1, further comprising:
roughening the selected surface;
removing impurities from the selected surface;
applying a primer bonding agent to the selected surface; and
applying a secondary bonding agent to the selected surface;

3. The method of claim 1, further comprising:
degreasing an outer surface of an inflatable bladder assembly;
applying a release agent to the outer surface of the inflatable bladder assembly;
selecting an amount by weight of rubber material based on the selected surface, the piping assembly and a geometry of the piping; and
wrapping the selected rubber material over the inflatable bladder.

4. The method of claim 1, further comprising securing the inflatable bladder to the piping prior to inflating the inflatable bladder.

5. The method of claim 1, further comprising closing supply valves of the piping prior to inflating the inflatable bladder.

6. The method of claim 1, comprising selecting one or more additional inner surfaces for applying a rubber liner and applying the rubber liner to the selected one or more additional inner surfaces.

7. The method of claim 1, further comprising inspecting the rubber liner for bonding and/or delamination.

8. The method of claim 1, further comprising removing the one or more containment devices.

9. A method of lining a piping assembly, the method comprising:
roughening internal surfaces of piping;
removing impurities from the internal surfaces;
applying a primer bonding agent to the internal surfaces;
applying a secondary bonding agent to the internal surfaces;
inserting one or more containment devices in the piping;
degreasing an outer surface of an inflatable bladder assembly;
applying a release agent to the outer surface of the inflatable bladder assembly;
selecting an amount by weight of rubber material based on the piping and a geometry of the piping;
wrapping the selected rubber material over the inflatable bladder;
introducing the inflatable bladder to an inner bore of the piping;
securing the inflatable bladder to the piping;
inflating the inflatable bladder to a predetermined pressure;
closing supply valves of the piping;
pre-heating an oven to a predetermined temperature;
introducing the piping to the oven and heating until a predetermined curing temperature; and
the piping is removed from the oven and cooled for a predetermined cooling time and an inner liner is formed on the inner surfaces.

10. The method of claim 9, further comprising removing the one or more containment devices.

11. The method of claim 9, further comprising inspecting a bonding of the rubber lining with the inner surfaces.

12. A piping assembly comprising:
piping;
an inflatable bladder coupled to the piping;
a valve coupled to the inflatable bladder;
a lid containment device connected to a top of the piping;
one or more containment coupled to the piping;
control circuitry connected to the inflatable bladder and having one or more processors configured to:
select an inner surface of the piping assembly for lining;
introduce rubber material into the inflatable bladder;
inflate the inflatable bladder to a predetermined pressure;
heat the piping assembly until a predetermined curing temperature and form a rubber liner on the inner surface.

13. The assembly of claim 12, the one or more processors configured to cool the piping assembly for a predetermined cooling time.

14. The assembly of claim 12, the one or more processers configured to inspect the rubber liner.

15. The assembly of claim 12, further comprising an oven for heating the piping 101.
